(19) United States
(12) Patent Application Publication
(10) Pub. No.: US 2019/0021823 A1
(43) Pub. Date: Jan. 24, 2019

(54) DRILL-LESS DENTAL IMPLANT AND USES THEREOF

(71) Applicant: CORTEX DENTAL IMPLANTS INDUSTRIES LTD., SHLOMI (IL)

(72) Inventors: PAOLO TRISI, PESCARA (IT); MEIR MAMRAEV, RISHON LEZION (IL); ZVI LASTER, PORIYA ELITE (IL)

(21) Appl. No.: 16/069,084

(22) PCT Filed: Dec. 22, 2016
(86) PCT No.: PCT/IL2016/051369

§ 371 Date: Jul. 10, 2018

(30) Foreign Application Priority Data
Jan. 10, 2016 (IL) 243523

(51) Int. Cl. A61C 8/00

(52) U.S. Cl. CPC A61C 8/0024; A61C 8/0037

(57) ABSTRACT

A drill-less dental implant, comprising: a penetrating element configured to linearly penetrate into a jaw bone, attached to a lower edge of a screw thread configured to be rotationally screwed into a jaw bone, and a prosthesis support attached to an upper edge of the screw thread. Additional embodiments of the drill-lest dental implant and uses thereof are disclosed herein.

### FIELD OF THE INVENTION

The present invention relates to dentistry. More particularly, the present invention relates to dental implants.

### BACKGROUND OF THE INVENTION

A dental implant is a surgical component that interfaces with a jaw bone to support dental prosthesis such as a crown, bridge, denture, and facial prosthesis. Some types of dental implants rely on the process of osseointegration, where the dental implant forms an intimate bond with the jaw bone tissue. Osseointegration is facilitated for example by using titanium as a material for the preparation of a dental implant, and inclusion of pores in the dental implant to allow the growth of bone tissue extensions into the pores. Currently, prior to implanting a dental implant the jaw bone is drilled in order to facilitate insertion of the dental implant into the jaw bone. Following insertion of the dental implant into the jaw bone, a healing time is required for osseointegration to occur in order to increase the fixation of the dental implant in the jaw bone before loading the dental implant with either a dental prosthetic or an abutment to which a dental prosthetic is attached.

Prior the implantation of a dental implant, a drilling process is conducted, involving a series of drills, each with an increasing diameter, in order to prepare a hole into which the dental implant is to be placed. The drilling process has several disadvantages, for example, inability to control the direction of drilling, and loss of jaw bone tissue during drilling which results in a low amount of jaw bone tissue that is left to hold the dental implant, especially when there is a need to implant the dental implant in a narrow jaw bone tissue, like in the front side of the lower jaw.

It is therefore an object of the present invention to provide a dental implant that allows implanting the dental implant without a need for a drilling process prior to implantation, and a method for implanting the drill-less dental implant. Further objects and advantages of this invention will appear as the description proceeds.

### SUMMARY OF THE INVENTION

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

According to one aspect of the present invention, there is provided a drill-less dental implant, comprising: a penetrating element configured to linearly penetrate into a jaw bone, attached to a lower edge of a screw thread configured to be rotationally screwed into a jaw bone, and a prosthesis support attached to an upper edge of the screw thread.

According to one embodiment, the penetrating element comprises a sharp smooth tip.

According to yet another embodiment, the penetrating element comprises a sharp smooth tip and an elongated smooth cylinder positioned between the sharp smooth tip and the screw thread.

According to a further embodiment, the height of the penetrating element constitutes a range of substantially 25% to 33% of the total height of the drill-less dental implant.

According to yet a further embodiment, the diameter of the upper edge of the drill-less dental implant is substantially higher than the diameter of the lower edge of the penetrating element.

According to still a further embodiment, the diameter of the upper edge of the drill-less dental implant is at least 3 millimeters.

According to an additional embodiment, the core of the drill-less dental implant is conical.

According to yet an additional embodiment, the core of the drill-less dental implant is cylindrical at the upper part and conical at the lower part of the drill-less dental implant.

According to another aspect of the present invention, there is provided a method for implanting a drill-less dental implant in a jaw bone, comprising: puncturing a starter hole in a jaw bone; linearly penetrating a penetrating element of a drill-less dental implant into the jaw bone through the starter hole; rotationally screwing and linearly penetrating the drill-less dental implant into the jaw bone, until the drill-less dental implant is inserted into the jaw bone in a desired depth.

According to one embodiment, the puncturing of a starter hole in a jaw bone is accomplished by using a penetrating element of the drill-less dental implant.

According to another embodiment, the method for implanting a drill-less dental implant in a jaw bone further comprises before puncturing a starter hole in a jaw bone, drilling a starter drill in the jaw bone.

According to yet another embodiment, the method for implanting a drill-less dental implant in a jaw bone further comprises during the linearly penetrating a penetrating element of a drill-less dental implant into the jaw bone through the starter hole, and/or during rotationally screwing and linearly penetrating the drill-less dental implant into the jaw bone, adjusting the direction of insertion of the drill-less dental implant into the jaw bone.

According to still another embodiment, adjusting the direction of insertion of the drill-less dental implant into the jaw bone comprises tilting the drill-less dental implant to a desired direction.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding, the description taken with the drawings making apparent to those skilled in the art how several forms may be embodied in practice.

In the drawings:

FIG. 1 schematically illustrates, according to an exemplary embodiment, a perspective view of a prior art dental implant requiring drilling of a jaw bone before implantation.

FIGS. 2A and 2B schematically illustrate, according to an exemplary embodiment, a perspective view of a drill-less dental implant according to the present invention.

FIG. 3 schematically illustrates, according to an exemplary embodiment, a cross-section view of a jaw bone.

FIGS. 4A-E schematically illustrate, according to exemplary embodiments, steps of a method for implanting a drill-less dental implant in a jaw bone.

### DESCRIPTION OF THE PREFERRED EMBODIMENTS

Before explaining at least one embodiment in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale.

For clarity, non-essential elements were omitted from some of the drawings.

One aim of the present invention is to provide a dental implant the does not require a drilling process on a jaw bone prior to the implantation of a dental implant.

Another aim of the present invention is to provide a dental implant that enables compression of a jaw bone tissue during the implantation of the dental implant.

Yet another aim of the present invention is to provide a dental implant that enables adjustment of the direction of insertion of the dental implant into a jaw bone during the implantation of the dental implant.

A further aim of the present invention is to provide a method for implanting a dental implant without a need for drilling a jaw bone prior the implantation.

Yet a further aim of the present invention is to provide a method for implanting a dental implant that enables compression of a jaw bone tissue during the implantation of the dental implant.

Still a further aim of the present invention is to provide a method for implanting a dental implant that enables adjustment of the direction of insertion of the dental implant into a jaw bone during the implantation of the dental implant.

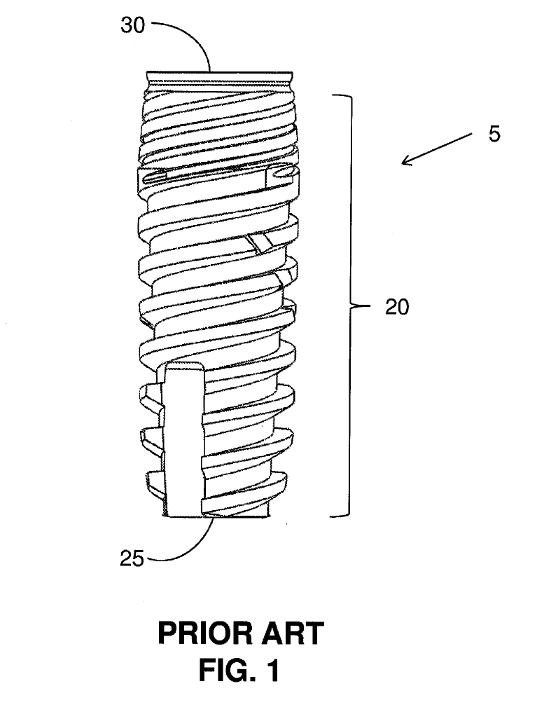

FIG. 1 schematically illustrates, according to an exemplary embodiment, a perspective view of a prior art dental implant 5 requiring a drilling process of a jaw bone before implantation. The prior art dental implant 5 comprises a screw thread 20 configured to be rotationally screwed into a drilled hole in a jaw bone, and a prosthesis support 30 configured to support a dental prosthesis, for example a crown, a bridge and a denture. The prosthesis support 30 is positioned at the upper edge of the prior art dental implant 1. In addition, the lower edge 25 of the prior art dental implant 5 is typically blunt as illustrated in FIG. 1. Furthermore, the core of the prior art dental implant is substantially cylindrical, in other words, the diameter of the lower edge 25 is substantially similar to the diameter of the upper edge, where the prosthesis support 30 is positioned.

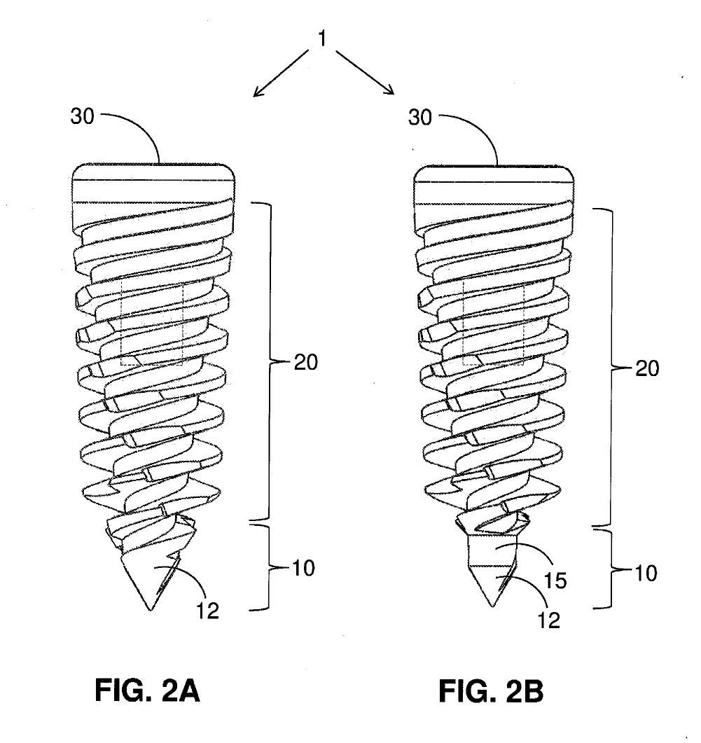

FIGS. 2A and 2B schematically illustrate, according to an exemplary embodiment, a perspective view of a drill-less dental implant 1 according to the present invention. The drill-less dental implant 1 comprises a screw thread 20 configured to be rotationally screwed into a jaw bone, and a prosthesis support 30 configured to support a dental prosthesis and attached to the upper edge of the screw thread 20. Additionally, the drill-less dental implant 1 further comprises a penetrating element 10 configured to linearly penetrate into a jaw bone, attached to a lower edge of the screw thread 20. According to one embodiment, illustrated in FIG. 1A, the penetrating element 10 comprises a sharp smooth tip 12. According to another embodiment, illustrated in FIG. 2B, the penetrating element 10 comprises a sharp smooth tip 12 and an elongated smooth cylinder 15 positioned between the sharp smooth tip 12 and the screw thread 20. It should be noted that the embodiments of the penetrating element 10 illustrated in FIGS. 1A and 1B are only exemplary embodiments, and that any shape of the penetrating element 10 that allows linear penetration into a jaw bone is under the scope of the present invention. According to another embodiment, the height of the penetrating element 10 constitutes a range of substantially 25% to 33% of the total height of the drill-less dental implant 1. According to yet another embodiment, the diameter of the upper edge of the drill-less dental implant 1 is substantially higher than the diameter of the lower edge of the penetrating element 10. According to a further embodiment, the diameter of the upper edge of the drill-less dental implant 1 is at least 3 millimeters. According to an exemplary embodiment illustrated in FIGS. 2A and 2B, the core of the drill-less dental implant is conical. According to another embodiment, the core of the drill-less dental implant is cylindrical at the upper part and conical at the lower part of the drill-less dental implant.

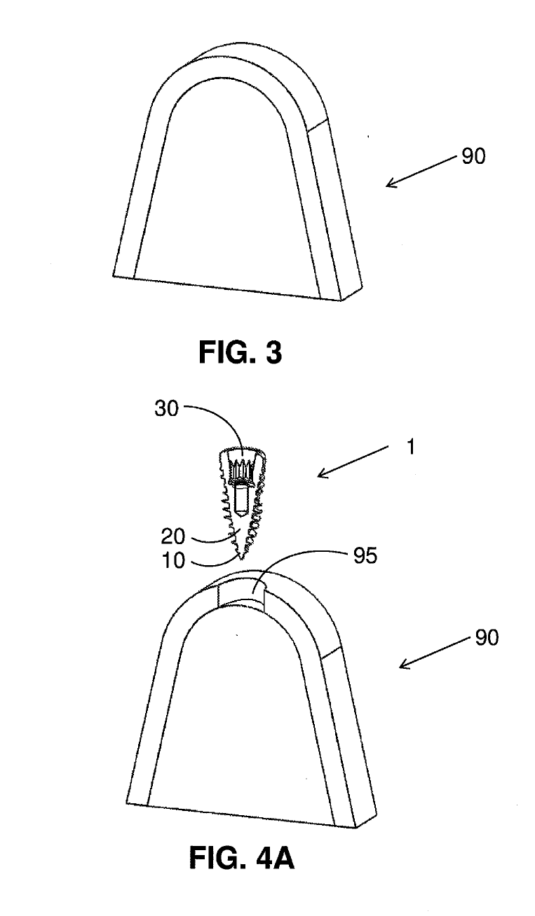

FIG. 3 schematically illustrates, according to an exemplary embodiment, a cross-section view of a jaw bone 90.

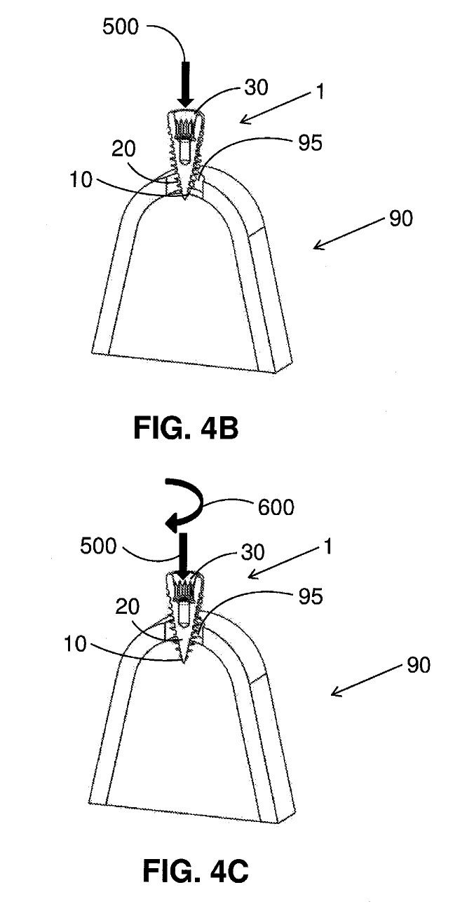

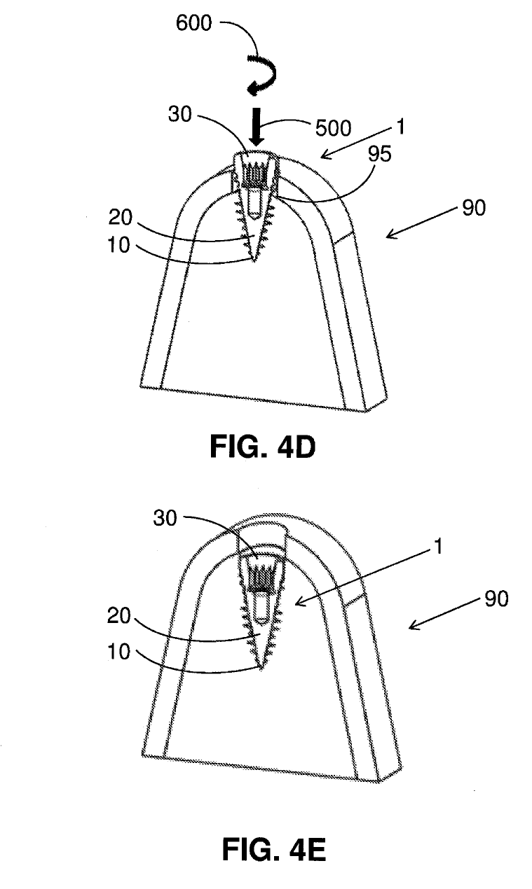

FIGS. 4A-E schematically illustrate, according to exemplary embodiments, steps of a method for implanting a drill-less dental implant 1 in a jaw bone 90, showing a cross-section view of a jaw bone 90 and a cross-section view of a drill-less dental implant 1 during the operation of the method. The method for implanting a drill-less dental implant 1 in a jaw bone 90 comprises:
puncturing a starter hole 95 in a jaw bone 90, as illustrated in FIG. 4A.
linearly penetrating the penetrating element 10 of the drill-less dental implant 1 into the jaw bone 90 through the starter hole 95, as indicated with arrow 500 in FIG. 4B;
rotationally screwing and linearly penetrating the drill-less dental implant 1 into the jaw bone 90, as indicated with arrows 600 and 500, respectively, in FIGS. 4C and 4D, until the drill-less dental implant 1 is inserted into the jaw bone 90 in a desired depth, as illustrated in FIG. 4E.

According to one embodiment, puncturing a starter hole 95 in a jaw bone 90 is accomplished by using the penetrating element 10 of the drill-less dental element 1.

According to another embodiment, the method for implanting a drill-less dental implant 1 in a jaw bone 90 further comprises before puncturing a starter hole 95 in a jaw bone 90, drilling a starter drill in the jaw bone 90.

According to Another embodiment, in case there is a need to adjust the direction of penetration of the drill-less dental implant 1 into the jaw bone 90, the method for implanting a drill-less dental implant 1 in a jaw bone 90 further comprises during the linearly penetrating a penetrating element 10 of a drill-less dental implant 1 into the jaw bone 90 through the starter hole 95, and/or during rotationally screwing and linearly penetrating the drill-less dental implant 1 into the jaw bone 90—adjusting the direction of insertion of the drill-less dental implant 1 into the jaw bone 90. This may be accomplished for example by tilting the drill-less dental implant 1 to a desired direction during the linear penetration of the penetrating element 10 into the starter hole 95, and or during the rotational screwing and linear penetration of the drill-less dental implant 1 into the jaw bone 90.

One advantage of the method for implanting a drill-less dental implant 1 of the present invention over the currently widely used method for implanting a dental implant involving a drilling process of a hole in a jaw bone for accommodating the dental implant, is that the method of the present invention allows adjustment of the direction of penetration of the drill-less dental implant 1 into the jaw bone during the linear penetration, and/or during the rotational screwing and linear penetration of the drill-less dental implant 1 into the jaw bone, without causing damage to the jaw bone tissue, in comparison to the method involving drilling in the jaw bone tissue where any mistake in the drilling may complicate the implantation procedure and require a long and unpleasant process of bone building to fill-in the undesired loss of jaw bone tissue due to the incorrect drilling. The drill-less dental implant 1 and the method for implantation of the present invention negates this kind of complication, as no drilling of the jaw bone is needed. Nevertheless, In some embodiments, a starter drill only may be needed in order to facilitate the penetration of the drill-less dental implant into the jaw bone.

Another advantage of the method for implanting a drill-less dental implant 1 of the present invention is its suitability to narrow jaw bones, like the frontal side of the lower jaw. Drilling a hole in such narrow jaw bone tissues removes a great amount to tissue from the jaw bone while the mass and strength of the remaining tissue may not be enough for stably accommodate a dental implant. On the other hand, implanting a drill-less dental implant 1 according to the present invention does not require removal of jaw bone tissue, thus leaving enough tissue to stably accommodate the drill-less dental implant 1.

Yet another advantage of the method for implanting a drill-less dental implant 1 of the present invention is compression of a jaw bone tissue that is achieved by implanting the drill-less dental implant 1 without pre-drilling of the jaw bone. Drilling a hole in the jaw bone removes jaw bone tissue, while the compression state of the remaining jaw bone tissue is not changed. On the other hand, implanting the drill-less dental implant 1 of the present invention directly in a jaw bone compresses the jaw bone tissue that surrounds the site of implantation of the drill-less dental implant 1, and thus increases the forces that are exerted by the compressed jaw bone tissue towards the drill-less dental implant 1. As a result, the stability of the drill-less dental implant 1 in the jaw bone is increased.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A drill-less dental implant, comprising: a penetrating element configured to linearly penetrate into a jaw bone, attached to a lower edge of a screw thread configured to be rotationally screwed into a jaw bone, and a prosthesis support attached to an upper edge of the screw thread.

2. The drill-less dental implant of claim 1, wherein the penetrating element comprises a sharp smooth tip.

3. The drill-less dental implant of claim 1, wherein the penetrating element comprises a sharp smooth tip and an elongated smooth cylinder positioned between the sharp smooth tip and the screw thread.

4. The drill-less dental implant of claim 1, wherein the height of the penetrating element constitutes a range of substantially 25% to 33% of the total height of the drill-less dental implant.

5. The drill-less dental implant of claim 1, wherein the diameter of the upper edge of the drill-less dental implant is substantially higher than the diameter of the lower edge of the penetrating element.

6. The drill-less dental implant of claim 1, wherein the diameter of the upper edge of the drill-less dental implant is at least 3 millimeters.

7. The drill-less dental implant of claim 1, wherein a core of the drill-less dental implant is conical.

8. The drill-less dental implant of claim 7, wherein the core of the drill-less dental implant is cylindrical at the upper part and conical at the lower part of the drill-less dental implant.

9. A method for implanting a drill-less dental implant in a jaw bone, comprising:
puncturing a starter hole in a jaw bone;
linearly penetrating a penetrating element of a drill-less dental implant into the jaw bone through the starter hole; and
rotationally screwing and linearly penetrating the drill-less dental implant into the jaw bone, until the drill-less dental implant is inserted into the jaw bone in a desired depth.

10. The method for implanting a drill-less dental implant in a jaw bone of claim 9, wherein the puncturing a starter hole in a jaw bone is accomplished by using a penetrating element of the drill-less dental implant.

11. The method for implanting a drill-less dental implant in a jaw bone of claim 9, further comprising before puncturing a starter hole in a jaw bone, drilling a starter drill in the jaw bone.

12. The method for implanting a drill-less dental implant in a jaw bone of claim 9, further comprising during the linearly penetrating a penetrating element of a drill-less dental implant into the jaw bone through the starter hole, and/or during rotationally screwing and linearly penetrating the drill-less dental implant into the jaw bone, adjusting the direction of insertion of the drill-less dental implant into the jaw bone.

13. The method for implanting a drill-less dental implant in a jaw bone of claim 12, wherein adjusting the direction of insertion of the drill-less dental implant into the jaw bone comprises tilting the drill-less dental implant to a desired direction.
